(19) United States
(12) Patent Application Publication
(10) Pub. No.: US 2004/0167996 A1
(43) Pub. Date: Aug. 26, 2004

(54) Computer system having a virtualized I/O device

(76) Inventors: Akihiro Takamura, Koganei (JP); Yoshio Miki, Kodaira (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/629,804

(22) Filed: Jul. 30, 2003

(30) Foreign Application Priority Data
Feb. 25, 2003 (JP) 2003-046885

(51) Int. Cl. G06F 3/00

(52) U.S. Cl. 710/5

(57) ABSTRACT

The subject of the present invention is to make an I/O device of a server computer available from a client computer. A hypervisor that stands between an OS and hardware carries out virtualization of the I/O device.

### BACKGROUND OF THE INVENTION

1. Field of the Invention

The present invention relates to a computer system having processor nodes connected via a network, allowing an I/O device connected to a particular processor node to be accessed from even another processor node.

2. Description of the Prior Art

There are found many cases that a computer system is configured by linking a plurality of processor nodes having different functions via a network, for the reasons such as reduction of hardware cost and simplification of a system architecture. However, in the computer system where a plurality of processor nodes having different functions are linked via a network, as described above, it is often the cases that there exists an I/O device that is connected only to a particular processor node. In this occasion, in order to use the particular I/O device from another processor node, it is necessary to log in the processor node to which the I/O device is connected, or to carry out data transfer between nodes.

Conventionally, OS (Operating System) has provided a function allowing the I/O device connected to a particular processor node to be accessed from an arbitrary processor node, so as to enhance the convenience of such a computer system as describe above. Here, this function is referred to as “I/O device virtualization function”. Hereinafter, the processor node having the I/O device will be referred to as “server computer”, and a computer accessing the I/O device of the server computer will be referred to as “client computer”. For example, as described in Japanese Laid-Open Patent Application (JP-A) No. 10-21203, the OS of the client computer has to be provided with a function capable of accessing the I/O device of the server computer, so that the OS of the client computer issues an access request to the I/O device of the server computer.

The virtualization function of the I/O device according to the OS has been implemented as the following. Here, a case is assumed that an application program in a client computer reads out a file on the I/O device, which is connected to a server computer. The client computer and the server computer are connected via a network. When the application program in the client computer reads the file, a file read-out request is transmitted to a file system, which is apart of the OS. According to a logical name of the file, the file system is informed of the server computer to which the I/O device containing the intended file is connected and a logical name of the file on the server computer. Then, the file system of the client computer informs a file system of the server computer, via the network, of the logical name of the intended file on the server computer. The file system as a part of the OS of the server computer specifies an I/O device containing the intended file and a device driver for carrying out input/output in/from the I/O device, according to the logical name of the intended file. The device driver reads out the intended file by issuing a read command to the I/O device. The file system of the server computer transmits the file thus read out to the file system of the client computer via the network. The file system of the client computer transmits the file thus read out to the application program. According to the above series of processes, it is possible for the program in the client computer to read out the file in the I/O device that is connected to the server computer.

In an actual computer system, however, there are many cases that such an OS-based I/O device virtualization function is unusable. This is because the I/O device virtualization function is available only between identical operation systems, in many occasions, and further, a plurality of types of OS are mixed in one computer system in general. Virtualization of an I/O device is available only between the identical operating systems, because a method for I/O device virtualization varies with each type of the OS. Further, a reason why a computer system is configured with a plurality of types of OS is as the following: In general, a computer system is not constructed all at once but is constructed after accumulated system extension. Hardware, an OS, and software, which are the most suitable at each stage are selected at the time of such system extension, and therefore a plurality of types of OS exist in a mixed manner within the entire computer system.

In the conventional arts as described above, there is a problem that in a computer system comprising a server computer and a client computer, connected via a network, when an OS of the server computer and an OS of the client computer are different from each other, an I/O device connected to the server computer cannot be used from the client computer.

### SUMMARY OF THE INVENTION

An objective of the present invention is, in a computer system comprising a server computer and a client computer connected via a network, to allow the client computer to use an I/O device connected to the server computer, without changing the operating systems on any of the server computer and the client computer, even when those operating systems are different from each other.

In order to achieve the above objective, in the present invention, a hypervisor is provided, which operates in close to a hardware hierarchy, rather than the OS hierarchy. A hypervisor of the client computer comprises a logical I/O device access detecting section for detecting an access to an I/O device of the server computer, without changing the operating system and a program on the operating system, and virtual I/O client processing for transmitting a command to the I/O device of the server computer via a network when there is an access to the I/O device of the server computer. A hypervisor of the server computer comprises virtual I/O sever processing, which receives the command to the I/O device from the network, and issues the command to the I/O device.

### BRIEF DESCRIPTION OF THE DRAWINGS

FIG. 1 is an illustration showing a configuration of a computer system for carrying out the present invention;

FIG. 2 is software stored in a hard disk of a client computer;

FIG. 3 is software stored in a hard disk of a server computer;

FIG. 4 is a flowchart showing read processing;

FIG. 5 is a flowchart showing write processing;

FIG. 6 is a flowchart showing a memory protection interrupt processing of the client computer;

FIG. 7 is a flowchart showing a memory protection interrupt processing of the server computer;

FIG. 8 is a flowchart showing a virtual I/O processing of the client computer;

FIG. 9 is a flowchart showing NIA (Network Interface Adaptor) receiving interrupt processing of the server computer;

FIG. 10 is a flowchart showing a virtual I/O processing of the server computer;

FIG. 11 is a flowchart showing a startup processing of the client computer;

FIG. 12 is a flowchart showing a startup processing of the server computer; and

FIG. 13 is a flowchart showing the virtual I/O processing of the client computer in the second embodiment of the present invention.

### DESCRIPTION OF THE PREFERRED EMBODIMENTS

In the first embodiment of the present invention, communication between a server computer and a client computer is carried out by use of a protocol, which is determined by both the hypervisor of the server computer and that of the client computer. In the meantime, in the second embodiment of the present invention, the communication between the server computer and the client computer is carried out by use of a protocol of the operation system, which operates on the server computer.

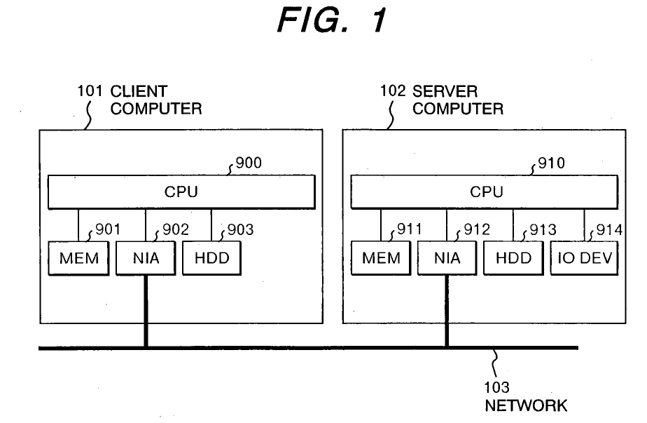

In FIG. 1, there is shown a computer system that is used commonly in both the first and the second embodiments. The computer system of these embodiments comprises at least one client computer 101, at least one server computer 102, and a network 103, which interconnects these computers.

The client computer 101 comprises a memory 901 for storing a program and data, a processor 900 for carrying out processing according to the program within the memory 901, an NIA (Network Interface Adaptor) 902 for establishing connection to the network and a HDD (hard disk drive) 903 for retaining the program and the data.

Similarly, the sever computer 102 comprises a memory 911 for storing a program and data, a processor 910 for carrying out processing according to the program within the memory 911, an NIA 912 for establishing connection to the network, a HDD 913 for retaining the program and the data, and an I/O device 914. Here, the I/O device 914 is assumed to be, for example, a removable disk drive.

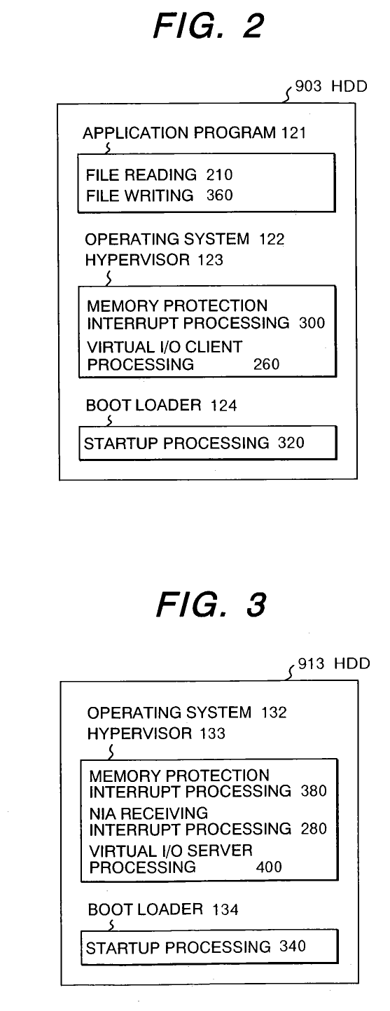

In FIG. 2, contents of the HDD 903 in the first and the second embodiments are shown. In the HDD 903, there are stored an application program 121, an operating system 122, a hypervisor 123, and a boot loader 124.

The application program 121 is a program including file reading 210 and file writing 360, and it carries out reading and writing from/to the I/O device 914, which is connected to the server computer 102, according to a function of the hypervisor. The hypervisor 123 includes memory protection interrupt processing 300 and virtual I/O client processing 260. When the application program 121 carries out the file reading 210 and the file writing 360, the memory protection interrupt processing 300 detects a read command and a write command to the logical I/O device, using memory protection control of the processor 900, and passes a control to the hypervisor. The virtual I/O client processing 260 is started up by the memory protection interrupt processing 300, and carries out reading and writing from/to the I/O device 914, which is connected to the server computer 102 via the network 103. At the time of starting up the client computer 101, the boot loader 124 activates the hypervisor 123 prior to activating the operating system 122, in order to allow the memory protection interrupt processing 300 of the hypervisor 123 to be called when a memory protection interrupt occurs.

Here, in the application program 121 of the embodiments of the present invention, both file reading 210 and file writing 360 are included. However, the embodiments are the same as described above in the case where only either one of the file reading 210 and the file writing 360 is included.

In FIG. 3, contents of the HDD 913 in the first embodiment are shown. In the HDD 913, there are stored an operating system 132, a hypervisor 133, and a boot loader 134.

The hypervisor 133 includes memory protection interrupt processing 380 and NIA receiving interrupt processing 280. In the memory protection interrupt processing 380, the NIA receiving interrupt processing 280 of the hypervisor 133 is allowed to be called prior to calling the NIA receiving interrupt processing of the operating system 132. In the NIA receiving interrupt processing 280, the virtual I/O server processing 400 is called when a read/write request to the I/O device 914 arrives from the client computer 101 via the network 103. The virtual I/O client processing 260 carries out read/writing from/to the I/O device in response to the read/write request. When the server computer 102 is started up, the boot loader 134 activates the hypervisor 133 prior to activating the operating system 132, so that the memory protection interrupt processing 380 and the NIA receiving interrupt processing 280 of the hypervisor 133 are called, respectively, when a memory protection interrupt and an NIA receiving interrupt occur.

At the time of starting up the server computer 102, the boot loader 134 allows the hypervisor 133 to be activated prior to activating the operating system 132, so that the NIA receiving interrupt processing 280 of the hypervisor 133 is called when an NIA receiving interrupt occurs.

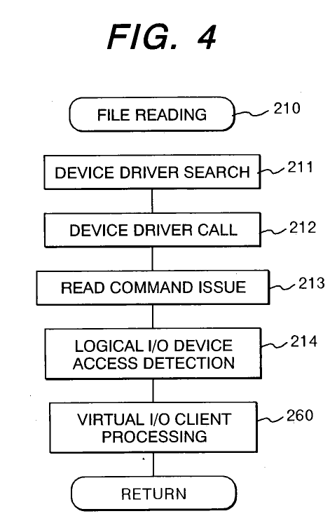

In FIG. 4, a procedure for file reading is shown in detail, which is used in both the first and the second embodiments.

When the application program 121 of the client computer 101 carries out the file reading, firstly the operating system 122 executes device driver search 211. The device driver is software to make an I/O device available in the operating system. Since the device driver varies according to the I/O device, a device driver corresponding to the I/O device, which stores a file designated by the program, is searched.

Next, device driver call 212 is executed and the device driver found in the device driver search 211 is called up. Further the device driver executes read command issuance 213, and the read command is written in a memory address for controlling a logical I/O device. According to the read command issuance 213, a memory protection interrupt occurs by the memory protection interrupt function of the processor, and logical I/O device access detection 214 is executed. According to the memory protection interrupt, a control is passed to the memory protection interrupt processing 300 of the hypervisor. According to the hypervisor, virtual I/O client processing 260 is executed and reading from the I/O device of the server computer is completed.

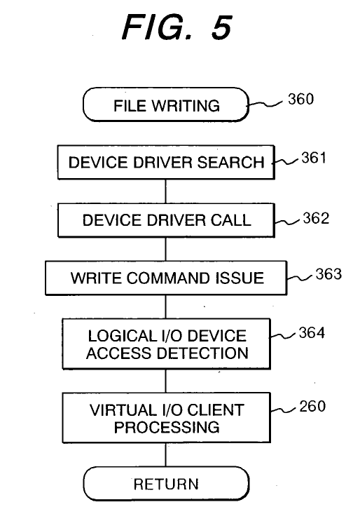

In FIG. 5, a procedure for file writing is shown in detail, which is commonly used in both the first and the second embodiments. The writing procedure is basically the same as the file reading procedure in FIG. 4, but there is one different point that a write command issuance 363 is executed instead of the read command issuance 213.

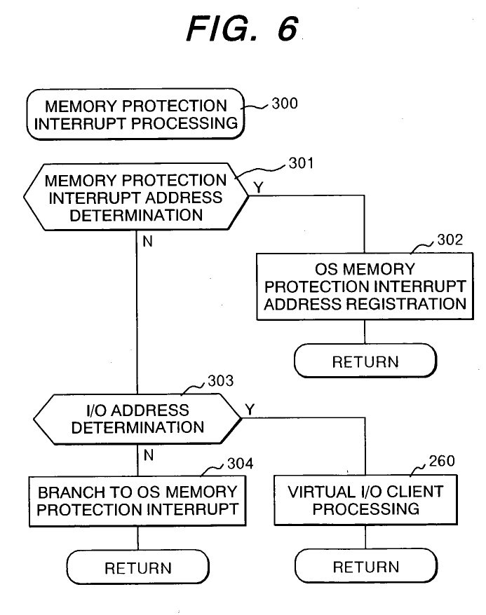

In FIG. 6, a procedure of memory protection interrupt processing 300 is shown in detail, which is commonly used in both the first and the second embodiments. The memory protection interrupt processing 300 is a program within the hypervisor, which is executed by the client computer 101. This program is called by a memory protection interrupt that is generated when read/write occurs to a particular memory address. According to the read/write address to the memory, which has triggered the interrupt, the memory protection interrupt processing 300 carries out the following three processes: (1) detecting a read command or a write command to the logical I/O device and calling the virtual I/O client processing 260, (2) when the OS executes writing to the memory protection interrupt address, registering an OS memory protection interrupt destination address, and (3) branching to the OS memory protection interrupt destination address, if the interrupt occurs due to a reason except the reason as described above.

When the memory protection interrupt processing 300 is called by the memory protection interrupt, firstly, memory protection interrupt address determination 301 is carried out, and determines whether or not a cause of the memory protection interrupt is writing to the branch destination address of the memory protection interrupt. If it is writing to the branch destination address of the memory protection interrupt, in “OS memory protection interrupt address registration 302”, data intended to be written in the branch destination address is registered in the branch destination address in the process of “branch to the OS memory protection interrupt 304”, and then the memory protection interrupt processing 300 ends. Next, the “I/O address determination 303” is carried out, and it is determined whether or not a cause of the memory protection interrupt is writing to a memory address of the logical I/O device, and whether it is an issuance of a read command or a write command to the logical I/O device. If it is an issuance of a read command or a write command to the logical I/O device, “Virtual I/O client processing 260” is called, and the memory protection interrupt processing 300 ends. If it is not writing to the I/O address, the process of “branch to the OS memory protection interrupt 304” is executed, and the process branches to the OS memory protection interrupt.

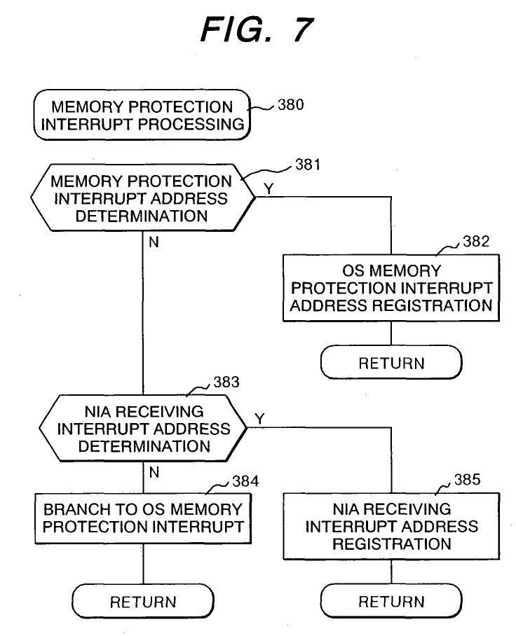

In FIG. 7, a procedure of memory protection interrupt processing 380 on the side of a server computer is shown in detail, which is commonly used in both the first and the second embodiments. The memory protection interrupt processing 380 is a program within the hypervisor that is executed by the server computer 102. This program is called by a memory protection interrupt that is generated when read/write occurs to a particular memory address. According to the read/write address to the memory, which has triggered the interrupt, the memory protection interrupt processing 380 carries out the following three processes: (1) when the OS executes writing to NIA receiving interrupt address, registering the OS memory protection interrupt destination address, (2) when the OS executes writing to the memory protection interrupt address, registering the OS memory protection interrupt destination address, and (3) branching to the OS memory protection interrupt destination address, if the interrupt occurs due to a reason except for the reason as described above.

When the memory protection interrupt processing 380 is called by the memory protection interrupt, firstly, memory protection interrupt address determination 381 is carried out, and determines whether or not a cause of the memory protection interrupt is writing to the branch destination address of the memory protection interrupt. If it is writing to the branch destination address of the memory protection interrupt, in the process of “OS memory protection interrupt address registration 382”, data intended to be written in a branch destination address is registered in the branch destination address in the process of “branch to the OS memory protection interrupt 384”, and then the memory protection interrupt processing 380 ends. Next, the “NIA receiving interrupt address determination 383” is carried out, and it is determined whether or not a cause of the memory protection interrupt is writing to the branch destination address of the NIA receiving interrupt. If it is writing to the branch destination address of the NIA receiving interrupt, in the NIA receiving interrupt address registration 385, data intended to be written in the branch destination address is registered in the branch destination address in the process of “branch to the OS NIA receiving interrupt processing 289”, and then the memory protection interrupt processing 380 ends. If it is not writing to the branch destination address of the NIA receiving interrupt, the process of “branch to the OS memory protection interrupt 384” is executed, and the process branches to the OS memory protection interrupt.

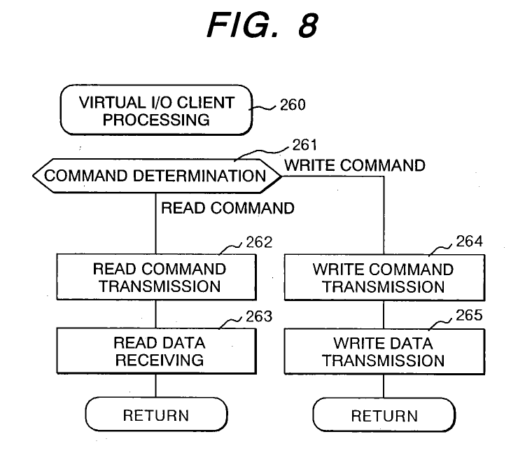

In FIG. 8, a procedure of virtual I/O client processing 260 in the first embodiment is shown in detail. The virtual I/O client processing is called by a memory protection interrupt, when writing to the memory address for controlling an I/O device is carried out, and executes read/write from/to the I/O device 914 connected to the server computer 102 via a network. Firstly, in the process of “command determination 261”, it is determined whether data written in the memory address for controlling the I/O device is a read command or a write command. When it is a read command, in the process of “read command transmission 262”, the read command and parameters of the read command (in the present embodiment, the parameters are a sector code and the number of sectors) are transmitted to the server computer 102. Subsequently, in the process of “read data receiving 263”, the server computer 102 receives the data obtained in the I/O read processing. When the data written in the memory address for controlling the I/O device is a write command, in the process of “write command transmission 264”, the write command and parameters of the write command (in the present embodiment, the parameters are a sector code and the number of sectors) are transmitted to the server computer 102. Subsequently, in the process of “write data transmission 265”, the data to be written is transmitted to the server computer 102.

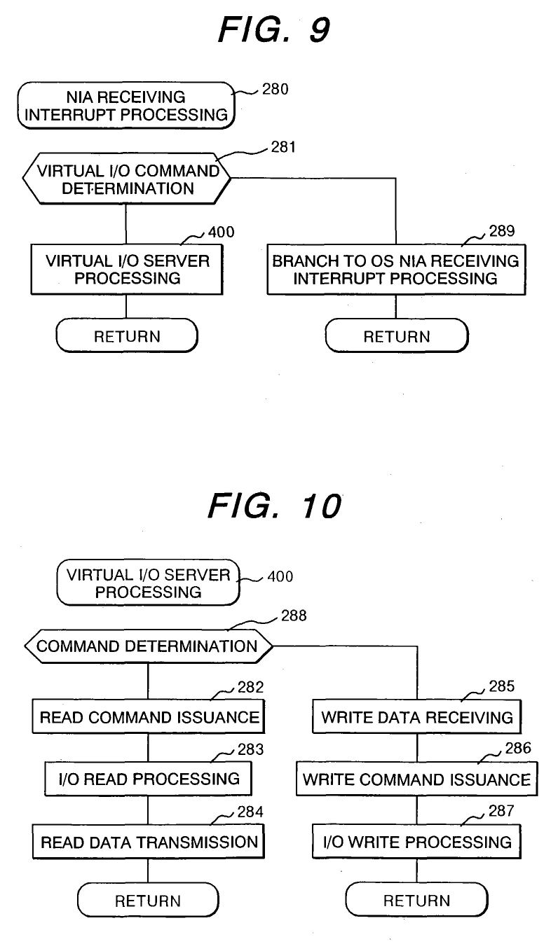

In Fig. 9, a procedure of NIA receiving interrupt processing 280 in the first embodiment is shown in detail. The NIA receiving interrupt processing 280 is a program within a hypervisor, which is executed in the server computer 102. When the NIA 912 receives data from a network, an interrupt occurs and then, this program is called. When the NIA receiving interrupt processing 280 is called, the process of “virtual I/O command determination 281” is executed. Then, it is determined whether the data received by the NIA is obtained by the process of “read command transmission 262” or the process of “write command transmission 264” of the client computer 101. If it is obtained by the read command transmission 262 or the write command transmission 264, the process of “virtual I/O server processing 400” is executed. In other cases, the process of “branch to OS NIA receiving interrupt processing 289” is executed and the receiving interrupt processing is executed by the OS.

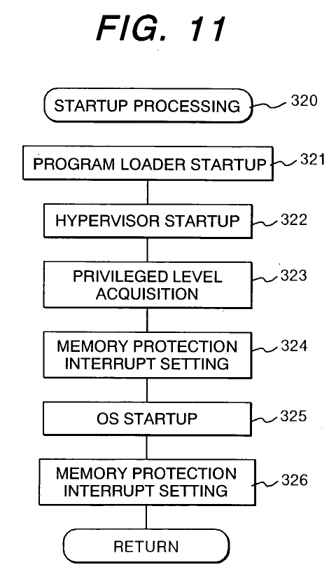

In FIG. 10, a procedure of the virtual I/O server processing 400 in the first embodiment is shown in detail. Firstly, the process of “command determination 288” is executed, and it is determined whether the command is a read command or a write command. If it is a read command, the process of “read command issuance 282” is carried out to the I/O device 914, and the read command and the parameters of the read command (in the present embodiment, these parameters are a sector code and the number of sectors) are written in the memory address of the I/O device. After the read command issuance 282 is carried out, the process of “I/O read processing 283” is executed within the I/O device, and data is read from the I/O device 914. Subsequently, the process of “read data transmission 284” is carried out, and the data read from the I/O device 914 is transmitted to the client computer 101. If the command is a write command, the data to be written is received from the client computer 101 in the process of “write data receiving 285”. When the process of “write command issuance 286” is carried out, “I/O write processing 287” is executed within the I/O device, and the data is written to the I/O device 914.

In FIG. 11, a procedure of “startup processing 320” of the client computer 101 is shown in detail, which is commonly used in both the first and the second embodiments. The startup processing 320 is called when the client computer 101 is started and it activates the hypervisor and the OS, together with setting the memory protection interrupt.

Firstly, a program loader is transferred to a memory from a disk, and “program loader startup 321” is carried out. The program loader transfers the hypervisor to the memory from the disk and carries out “hypervisor startup 322”. In order to monitor the read command issuance 213, the write command issuance 363 and a change in the memory protection interrupt address by use of a memory protection mechanism, the hypervisor carries out “privileged level acquisition 323” and “memory protection interrupt setting 324”. Then, setting is made such that a memory protection interrupt occurs when there is a writing or a reading to/from the memory address of the I/O device or the branch destination address of the memory protection interrupt, and the process branches to the memory protection interrupt processing 300.

Here, the privileged level will be explained. Generally, a processor is provided with a privileged level where an OS kernel operates and at least one non-privileged level where a user program operates. In the privileged level, entire hardware can be accessed without any restriction, whereas in the non-privileged level, it is not allowed to access the hardware at all. In the process of “privileged level acquisition”, an operation mode of the processor is switched to make the privileged level available, and allows the program to operate on the privileged level.

Subsequently, the program loader transfers the OS from the disk to the memory and carries out “OS startup 325”. The OS writes an address of the OS memory protection interrupt processing to a branch address of the memory protection interrupt in the process of “memory protection interrupt setting 326”. At this timing, conventionally, a memory protection interrupt processing has been set in the OS. However, in the embodiment of the present invention, a memory protection interrupt occurs, and the address is registered to a branch destination address in the “branch to the OS memory protection interrupt 304” within the “memory protection interrupt processing 300” of the hypervisor.

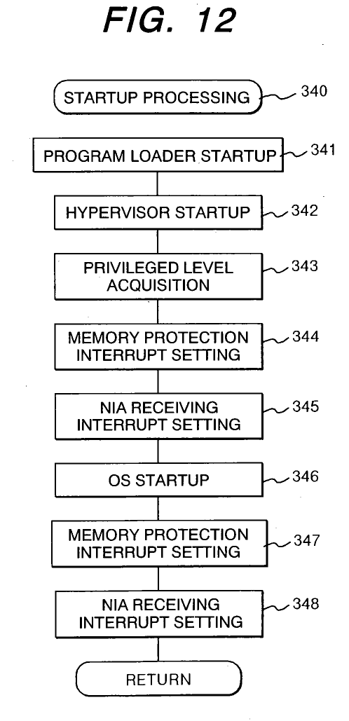

In FIG. 12, a procedure of startup processing in the server computer 102 in the first embodiment is shown in detail. The process of “startup processing 340” is called when the server computer 102 is started, and carries out activating the hypervisor and the OS, together with setting a memory protection interrupt and an NIA receiving interrupt.

Firstly, a program loader is transferred from a disk to a memory, and the process of “program loader startup 341” is carried out. The program loader transfers the hypervisor from the disk to the memory, and carries out the process of “hypervisor startup 342”. In order to monitor a change in the branch destination address of the NIA receiving interrupt and that of the memory protection interrupt by use of a memory protection mechanism, the hypervisor carries out “privileged level acquisition 343” and “memory protection interrupt setting 344”. Then, setting is made such that a memory protection interrupt occurs when there is a writing or a reading to/from the branch destination address of the memory protection interrupt and a branch destination address of the NIA receiving interrupt, and the process branches to the memory protection interrupt processing 380. Furthermore, according to “NIA receiving interrupt setting 345”, setting is made so that the process branches to the NIA receiving interrupt processing 280 when the NIA receives data.

Subsequently, the program loader transfers the OS from the disk to the memory, and carries out “OS startup 346”. In the process of “memory protection interrupt setting 347”, the OS carries out writing the address of the OS memory protection interrupt processing to a branch destination address of the memory protection interrupt. At this time, conventionally, the memory protection interrupt processing is set in the OS, but in the embodiment of the present invention, a memory protection interrupt occurs, and the address is registered to a branch destination address in the process of “branch to OS memory protection interrupt 384” within the “memory protection interrupt processing 380” of the hypervisor. Similarly, in the process of “NIA receiving interrupt setting 348”, the OS carries out writing the address of the OS NIA receiving interrupt processing to a branch destination address of the NIA receiving interrupt. At this time, conventionally, the NIA receiving interrupt processing is set in the OS, but in the embodiment of the present invention, a memory protection interrupt occurs, and the address is registered to as a branch destination address in the process of “branch to OS NIA receiving interrupt processing 289” within the “memory protection interrupt processing 380” of the hypervisor. According to the above procedure, it is possible to allow the memory protection interrupt and the NIA receiving interrupt to branch to the hypervisor.

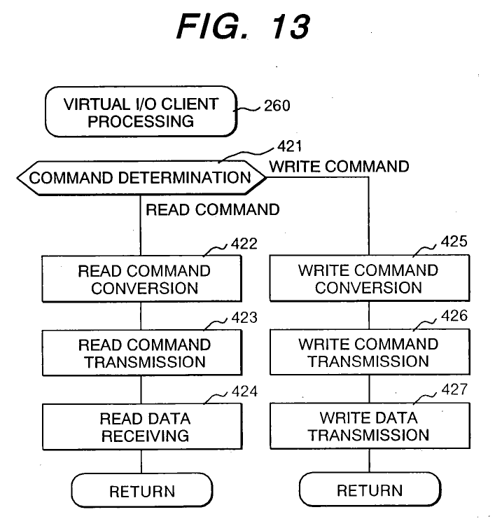

In FIG. 13, a procedure of “virtual I/O client processing 260” in the second embodiment is shown in detail. The second embodiment is different from the first embodiment in that the hypervisor converts a command to the I/O device of the server computer into a protocol which is able to be interpreted by the server computer, and then the command thus converted is transmitted to the server computer. Firstly, in the process of “command determination 421”, it is determined whether data written in the memory address of the I/O device is a read command or a write command.

If it is a read command, the process of “read command conversion 422” converts the command to a protocol which is able to be interpreted by the OS of the server computer. In the case where the OS of the server computer is UNIX (trademark registered in the U.S. and other countries, licensed exclusively through X/Open Company Ltd.), for example, the read command may be the data transmitted to the server computer, after the following is executed:

rsh<server computer>

dd if=<I/O device name>

skip=<read starting block number>

count=<the number of blocks to be read>.

The process of “read command transmission 423” transmits a command generated by the “read command conversion 422” to the server computer 102. Subsequently, the process of “read data receiving 424” receives a result obtained when the OS of the server computer 102 executes the read command.

If it is a write command, in the process of “write command conversion 425”, it is converted to a protocol which is able to be interpreted by the OS of the server computer. In the case where the OS of the server computer is UNIX, for example, the write command may be the data transmitted to the server computer, when the following is executed:

rsh<server computer>

dd of=<I/O device name>

seek=<write starting block number>

count=<the number of blocks to be written>.

The process of “write command transmission 426” transmits a command generated by the “write command conversion 425” to the server computer 102. Subsequently, the process of “write data transmission 427” transmits the data to be written to the server computer 102.

According to the embodiments to carry out the present invention, virtualization of the I/O device becomes possible by the hypervisor, it is possible to handle the I/O device as if it is connected to a client computer, even if it is actually connected to a server computer, without changing the operating systems or application programs of the server computer and the client computer.

Furthermore, in the second embodiment of the present invention, the virtual I/O client processing of the hypervisor of the above client computer transmits a read command or a write command to the server computer, in a protocol supported by the OS of the server computer.

Accordingly, since the virtualization of the I/O device becomes possible by the hypervisor of the client computer, just by introducing the hypervisor to the client computer, it is possible to handle the I/O device as if it is connected to a client computer, even if it is actually connected to a server computer, without changing the operating systems or application programs of the server computer and the client computer.

According to the present invention, when the OS of the client computer accesses a logical I/O device, the hypervisor issues a command to the I/O device of the server computer via a network. With this function, it is possible to access the I/O device of the server computer from the client computer without changing the OS or application programs, even when the OS of the client computer is different from that of the server computer.

What is claimed is:

1. A computer system having a virtualized I/O device, comprising:
a client computer having a first hypervisor and a first OS operating on the first hypervisor; and
a server computer having a second hypervisor, a second OS operating on the second hypervisor, and a physical I/O device, wherein
said client computer and said server computer are connected via a network,
said first hypervisor comprises:
logical I/O device access detecting means for detecting a logical I/O device access, which is directed to said physical I/O device of said server computer; and
virtual I/O client processing for transmitting to said server computer, via said network, a command to access said logical I/O device when said logical I/O device access is detected; and
said second hypervisor comprises virtual I/O server processing for receiving said command via said network and for issuing a command to said physical I/O device.

2. The computer system having a virtualized I/O device according to claim 1, wherein communication between said client computer and said server computer is performed on a protocol, which is determined by said first and second hypervisors.

3. The computer system having a virtualized I/O device according to claim 1, wherein communication between said client computer and said server computer is performed on a protocol of said second OS, which operates on said server computer.

4. The computer system having a virtualized I/O device according to claim 1, wherein said virtualized I/O client processing transmits to said server computer said command to access said logical I/O device, after converting said command into a protocol, which the second OS of said server computer is capable of interpreting.

5. The computer system having a virtualized I/O device according to claim 1, wherein said client computer has a memory protection control function and further has means for detecting a read command and a write command to said logical I/O device by use of said memory protection control function, and for passing control to said first hypervisor.

6. The computer system having a virtualized I/O device according to claim 5, further comprising means such that, in said client computer, upon reading/writing from/to a particular memory address, a memory protection interrupt occurs, and when a cause of said memory protection interrupt is either a read command issuance or a write command issuance to said logical I/O device, said virtual I/O client processing is called.

7. The computer system having a virtualized I/O device according to claim 6, wherein said first OS has means for searching a device driver corresponding to an I/O device which stores a file designated by an application program, and calling the device driver thus found as a result of the searching, and said device driver issues a read command and writes said read command in a memory address of the logical I/O device.

8. A computer system having a virtualized I/O device according to claim 1, wherein
said virtual I/O client processing comprises:
means for determining whether data written in a memory address for controlling an I/O device is a read command or a write command;
means for, when the data is a read command, transmitting to said server computer the read command and a parameter of the read command;
means for receiving data read out in I/O read processing by said server computer;
means for, when the data is a write command, transmitting to said server computer the write command and a parameter of the write command; and
means for transmitting data to be written to said server computer.
